(19) United States
(12) Patent Application Publication
(10) Pub. No.: US 2014/0372196 A1
(43) Pub. Date: Dec. 18, 2014

(54) SYSTEM AND METHOD FOR DISTRIBUTING PROMOTIONAL CERTIFICATES

(71) Applicant: Local Topia LLC, Alachua, FL (US)

(72) Inventor: Randall J. Arthur, Alachua, FL (US)

(21) Appl. No.: 14/308,145

(22) Filed: Jun. 18, 2014

Related U.S. Application Data
(60) Provisional application No. 61/836,273, filed on Jun. 18, 2013.

(51) Int. Cl. G06Q 30/02

(52) U.S. Cl. CPC G06Q 30/0239; G06Q 30/0225; G06Q 30/0234
USPC 705/14.26; 705/14.39; 705/14.34

(57) ABSTRACT

A system for distributing promotional certificates includes a system server and a user device. The system server has a processor and a memory. The memory is in communication with the processor and has at least one database embodied thereon. The database defines a plurality of users, a plurality of participating businesses, and a plurality of promotional certificates associated with the participating businesses. The processor is configured to associate in the memory each of the users with either an individual one of the participating businesses or a provider of the system server. The user device is associated with one of the users, and is in communication with the system server. The user device has a software application that is configured to present the promotional certificates for redemption at the participating businesses.

### CROSS REFERENCE TO RELATED APPLICATIONS

This application claims the benefit of U.S. Provisional Application No. 61/836,273, filed on Jun. 18, 2013. The entire disclosure of the above application is hereby incorporated herein by reference.

### BACKGROUND

Distributing digital coupons to mobile devices via the Internet is known. For example, entertainment, service, and trade businesses distribute coupons via text messages, mobile advertisements, branded and custom applications, e-mail, barcodes, and similar formats to consumers. However, distributing coupons can become costly and may lead to devaluation of products or services provided by businesses. One disadvantage of coupons is that coupons are commonly limited to a discount in either a monetary amount reduced from a purchase price of an item, or a percentage reduction of the purchase price. Coupons are only associated with savings or a reduction of a purchase price, giving consumers the impression that the product or service may not be worth the full product or service value.

Gift certificates and gift cards are generally preferred by consumers over coupons because they are used in place of money, and are therefore associated with spending money. The cost of redeeming a gift certificate or a gift card is typically less expensive than the cost associated with coupons. For these reasons, gift certificates and gift cards often create greater promotional results. However, known gift certificates and gift cards have been available mostly in paper or plastic formats, which has limited their use in promoting businesses.

With the growing market of mobile devices, there is a continuing need for a digital option having the characteristics of a gift certificate or a gift card, and which is more flexible, efficient, and effective than coupons at enticing consumers.

### SUMMARY

In concordance with the instant disclosure, a digital option having the characteristics of a gift certificate or a gift card, and which is more flexible, efficient, and effective than coupons at enticing consumers, is surprisingly discovered. The digital option of the disclosure is hereinafter referred to as “promotional certificates”.

The “promotional certificates” of the present disclosure share certain qualities with “gift certificates” and “gift cards”. It should also be understood that both promotional certificates and gift certificates/gift cards are also different from “coupons”. Coupons are directed to a discount in either a monetary amount reduced from a starting purchase price of an item, or a percentage reduction of the starting purchase price. Contrasted to this, gift certificates and gift cards are defined herein and under the “Credit Card Act of 2009” as “an electronic promise that is redeemable at a single merchant or an affiliated group of merchants that share the same name, mark, or logo; issued in a specified amount that may not be increased or reloaded; purchased on a prepaid basis in exchange for payment; and honored upon presentation by such single merchant or affiliated group of merchants for goods or services”. Gift certificates and gift cards therefore do not depend on a starting purchase price of the good or service.

As defined herein, promotional certificates are redeemable for a specific amount that may not be increased or reloaded, and are honored upon presentation to a participating business. It should therefore be understood that the promotional certificates of the present disclosure are different from coupons for the same reasons established hereinabove with respect to gift certificates and gift cards. The promotional certificates of the disclosure are also different from gift certificates and gift cards, in that they are not provided in paper or plastic form, but are instead presented on an electronic device of a user.

In one embodiment, a system for distributing promotional certificates includes a system server and a user device. The system server has a processor and a memory. The memory is in communication with the processor and has at least one database embodied thereon. The database defines a plurality of users, a plurality of participating businesses, and a plurality of promotional certificates associated with the participating businesses. The processor is configured to associate in the memory each of the users with either an individual one of the participating businesses or a provider of the system server. The user device is associated with one of the users, and is in communication with the system server. The user device has a software application that is configured to present the promotional certificates for redemption at the participating businesses.

In another embodiment, the system of calculates and provides a rebate for a participating business, which is based on the promotional certificates redeemed by users associated with the participating business in the system server. For example, the rebate can be calculated by the system server as a percentage of the value of all promotional certificates redeemed at the business by users who registered at the participating business, and are thereby associated with the participating business in the system server.

In yet another embodiment, the system server permits user registration, by the user device, through the scanning of a code on an advertisement at the participating business.

In a further embodiment, the user device has a location interface configured to detect when the user device is proximate the participating business at which the promotional certificate is redeemable. For example, the system may use global positioning capabilities to notify the user when a promotional certificate is available for a nearby participating business.

In another embodiment, a method of distributing promotional certificates includes the step of permitting the user device of the system to be in communication with the system server. The promotional certificates are then presented on the user device. The user is then allowed to select one of the promotional certificates for one of the participating businesses associated with the selected one of the promotional certificates. The one of the participating businesses associated with the selected one of the promotional certificates is then permitted to redeem the selected one of the promotional certificates on the user device. Upon redemption, the user device communicates to the system server that the selected one of the promotional certificates has been redeemed, so that the system server does not permit an additional redemption of the same promotional certificate.

According to one embodiment, a system for distributing promotional certificates includes a system server and at least one user device. The system server has a processor for executing instructions to present at least one promotional certificate, and a memory in communication with the processor. The memory includes at least one database embodied thereon. The at least one database has information defining the at least one promotional certificate. The at least one user device is in communication with the system server. A code disposed on an advertisement located at a promotional certificate participating business permits registration of the user by scanning the code with the user device. At least one user is permitted to register with the system and to redeem the at least one promotional certificate with the promotional certificate participating business.

According to another embodiment, a system for distributing promotional certificates includes a system server and at least one user device. The system server has a processor for executing instructions to present multiple promotional certificates, and a memory in communication with the processor. The memory includes at least one database embodied thereon. The at least one database has information defining and distinguishing the multiple promotional certificates. The at least one user device is in communication with the system server. The multiple promotional certificates are redeemed by a promotional certificate participating business. A rebate is created by the system and forwarded to the promotional certificate participating business. The rebate is calculated by the system as a percentage of a total value of an entirety of the multiple promotional certificates redeemed at the promotional certificate participating business during a predetermined period of time.

The present disclosure further provides a computer-implemented system and method for searching for the promotional certificates. The system includes a server having a memory with a plurality of databases. The databases store business data, user data, and promotional certificate data. The databases also may store relationships between the business data, the user data, and the promotional certificate data. The system is in communication with a multitude of mobile user devices via the Internet. The user devices employ a software program through which users are presented with promotional certificates from the system. The user may search for businesses by name, type, or geographical location.

In certain embodiments, the user device has a GPS system or GPS capabilities and will notify the user when a business, for which a promotional certificate is available, is nearby. A user can register with the system either online or by scanning a code such as a QR code or bar code on an advertisement at a promotional certificate participating business.

In another example, a user will register with the system by contacting a service provider. The service provider will enter information about the user including items such as user name, user address, user email address, and user billing information.

A user device selected by the user can be a web-based device such as a computer, or a mobile device such as a smart phone or a computer tablet. The user can register the user device with the service provider by downloading the software to the user device.

In an illustrative embodiment, the user may be required to pay a periodic fee, for example, a monthly fee, to maintain registration with the service. This allows the user to communicate with the system to download, for example, on a monthly basis, a set having a predetermined quantity (for example, 250) of promotional certificates available to the user. Each set of promotional certificates is valid for use in multiple different businesses that are registered members of the system via the service provider. Each successive month, the user can download a new set of certificates upon payment of the monthly fee to the service provider. Any individual promotional certificate can only be redeemed once per the given time period (for example, once per month).

In operation, the user can select a particular promotional certificate for redemption, for example, when at a restaurant that is one of multiple promotional certificate participating businesses. After notifying the promotional certificate participating business that the user has elected to redeem a promotional certificate, a designated person at the promotional certificate participating business validates the promotional certificate. The validation may also date- and time-stamp the promotional certificate, and the user device may then also notify the system server of the redemption.

It should be appreciated that the user is not required to provide identification during the validation and redemption process, as the mere provision of a valid promotional certificate on the user device provides sufficient identification to the system server that the user is registered. The validation in absence of identification is made possible only a registered user has access through a user device of a promotional certificate. For example, the designated person from the promotional certificate participating business can hit a digital/icon button provided on a screen of the user device, in order to redeem the promotional certificate.

The user can only be connected to one promotional certificate participating business at a time via the user device. The user has multiple options for receiving promotional certificate information. A set of promotional certificates provided to the user on a periodic basis can be personalized by the user to pre-select only those promotional certificate participating businesses favored by the user. The user can opt-out of receiving information from one or more selected promotional certificate participating businesses by notifying the service provider. The set of promotional certificates remains available to the user throughout the period (for example, for a one month time period).

Redeemed promotional certificates are tracked by the system such that each promotional certificate can only be used once during the period. A new or next promotional certificate for the same promotional certificate participating business that the user may prefer will be available each period, if the user continues to pay the periodic fees to the service provider. However, the user can only redeem one promotional certificate per promotional certificate participating business per the period.

A business will register with the system by contacting the service provider, who will enter parameters such as promotional certificate appearance, frequency of distribution, value, or the like into the system. In addition to the benefit of helping to drive customers to use a business, the system can provide a rebate to a promotional certificate participating business for a predetermined or limited period of time that is calculated by the system as a percentage of the value of all promotional certificates redeemed at that business by users who are registered at the participating business. The promotional certificate participating business can receive further awards by users that re-register at the same promotional certificate participating business. In operation, the promotional certificate may include a unique identifier such as a bar code or alphanumeric code that may be scanned or otherwise recorded by a business upon presentation of the promotional certificate. The businesses are also provided with feedback from the system related to registrations at that business such that the business can identify approximate numbers of registered users that are redeeming available promotional certificates over a predetermined or selected time period, thus providing the businesses with a participation percentage.

### BRIEF DESCRIPTION OF THE DRAWINGS

The above, as well as other advantages of the present disclosure, will become readily apparent to those skilled in the art from the following detailed description when considered in the light of the accompanying drawings in which:

FIG. 1 is a schematic diagram of a system for distributing promotional certificates according to an embodiment of the disclosure;

FIG. 2 is a flow diagram of a method for distributing promotional certificates according to an embodiment of the disclosure;

FIG. 3 is a flow diagram of the steps for registration of users and business participants in the system according to the method for distributing promotional certificates of FIG. 2;

FIG. 4 is a flow diagram of the steps for distributing promotional certificates to users via the software application on the user devices according to the method for distributing promotional certificates of FIG. 2;

FIG. 5 is a flow diagram of the steps for providing advertising for business participants through social media according to the method for distributing promotional certificates of FIG. 2;

FIG. 6 is a flow diagram of the steps for providing feedback to business participants based on promotional certificate redemption and providing a rebate to business participants based on specified parameters according to the method for distributing promotional certificates of FIG. 2; and

FIG. 7 is a schematic diagram of a database having users associated by a processor with either particular business participants or a provider of the system, for purposes of determining rebates to the particular business participants.

### DETAILED DESCRIPTION

The following detailed description and appended drawings describe and illustrate various embodiments of the disclosure. The description and drawings serve to enable one skilled in the art to make and use the disclosure, and are not intended to limit the scope of the disclosure in any manner. In respect of the methods disclosed, the steps presented are exemplary in nature, and thus, the order of the steps is not necessary or critical unless otherwise disclosed.

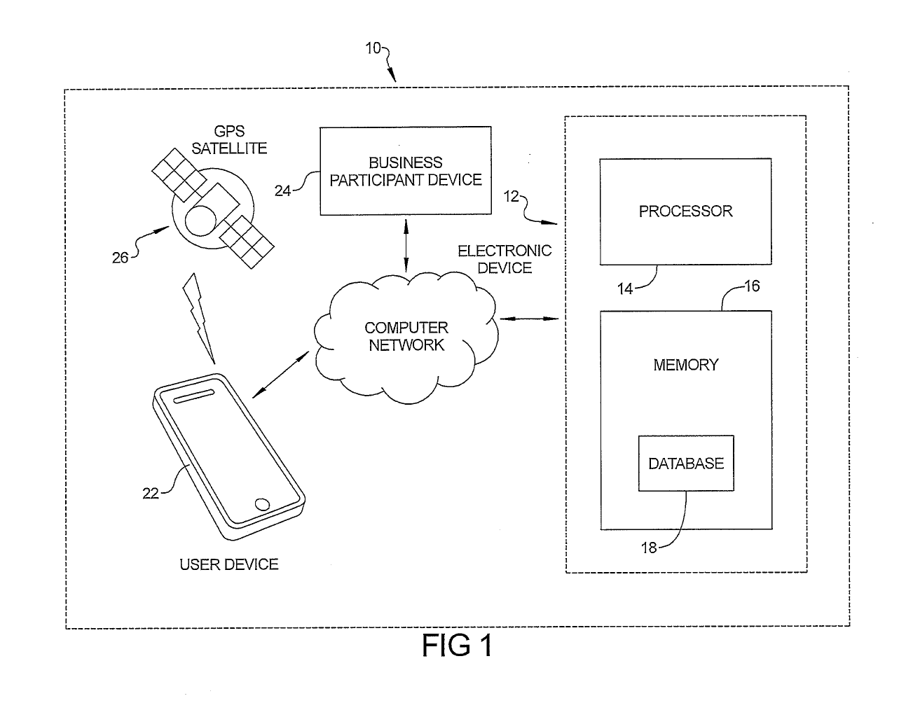

FIG. 1 illustrates a system 10 for distributing promotional certificates. The system 10 includes a system server 12 and a user device 22. The system 10 may further include a business participant device 24, such as a user interface of a business computer that allows a business participant to directly interact with the system 10.

The user device 22 can be a mobile device such as a smart phone or tablet computer, for example. The user device 22 could also be a desktop computer or similar device configured to permit a user to interact with the system 10, for example. Other types of user devices 22 permitting an interaction with the system 10 may also be used within the scope of the present disclosure.

The system server 12 may be any hardware device or program capable of storing and managing data such as the non-limiting example of a web server. The system 10 presents promotional certificates to the user device 22 that can be redeemed by a business participant upon presentation of a promotional certificate. The system server 12 may include a processor 14 and a memory 16. The processor 14 may be a central processing unit (CPU) or any other type of processor configured to execute instructions, for example, for presenting promotional certificates, presenting promotional certificate registration feedback to the business participant, and creating associations between the users and the business participants. The memory 16 is in communication with the processor 14. The memory 16 may be formed from a tangible, non-transitory computer readable medium. The memory 18 has a plurality of databases 18 embodied thereon. The databases 16 can store business data, user data, and promotional certificate data, as well associations created therebetween. The instructions to be executed by the processor 14 may also be stored on the memory 16 of the system server 12, as desired.

In the illustrative embodiment, the system server 12 is in communication with the user device 22 via a computer network 20 such as the Internet. However, in other embodiments the system server 12 can be in communication with the user device 22 via a local network, a regional network, or any global computer network, as desired.

The user device 22 employs a software program application, through which users are presented with promotional certificates from the system server 12. In particular embodiments, the promotional certificates may be presented on a regular basis such as daily, weekly, or monthly, for example. Business participants can be any goods- or service-providing business, such as clothing stores, restaurants, bars, hardware stores, gas stations, or the like. The present disclosure is not limited by the type of business participant.

The user can utilize the user device 22 to search for the business participant by name, type, or geographical location. The user device 22 can include a location interface such as a Global Positioning System (GPS) processor to receive and process signals sent from a GPS satellite 26 for obtaining location information of the business participant and/or the user device 22. In particular embodiments, the user device 22 notifies the user when a business participant for whom a promotional certificate is available is in a specified vicinity of the user.

Referring again to FIG. 1, the system server 12 is in communication with the business participant device 24, such as a business computer, via the computer network 20. The business participant device 24 allows business participants to input parameters such as promotional certificate appearance, frequency of distribution, and value of promotional certificates.

Additionally, the business participant device 24 allows business participants to create and modify banner advertisements displayed on the user devices 22 at any frequency, including every time a user accesses the software application. In a non-limiting example, the business participant communicates with registered users by informing the registered users of special events or offerings through the software application. In particular embodiments, the system server 12 calculates a quantity or a total monetary amount of the promotional certificates redeemed through the user device 22, and generates detailed feedback to business participants through the business participant device 24, such as by e-mailing a detailed report to the business participant.

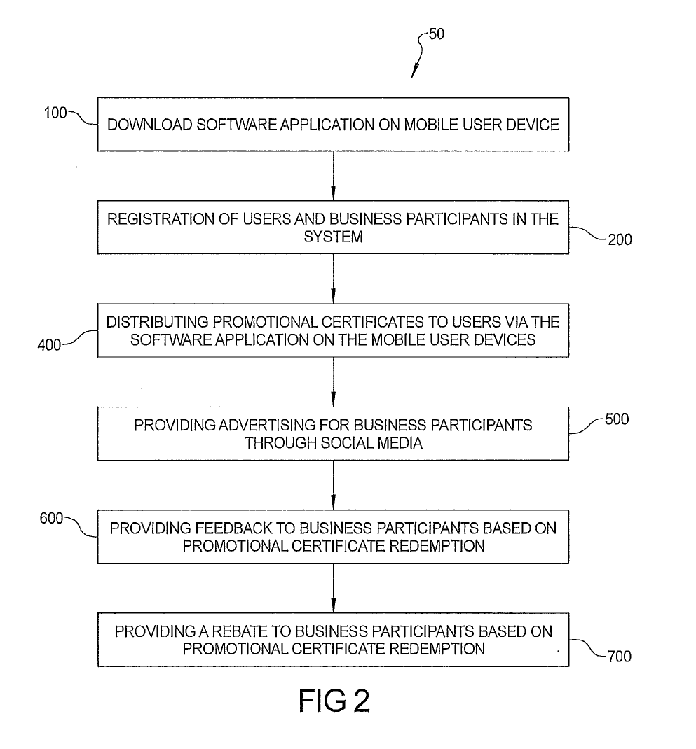

In an embodiment of the disclosure illustrated in FIG. 2, a method 50 for distributing promotional certificates is disclosed. The method 50 may include the system 10 for distributing promotional certificates described hereinabove. Initially, a software application is downloaded on a user device in a step 100. The software application allows a user to be presented with promotional certificates generated from the system 10. Users and business participants are registered in the system 10 in a step 200 by providing user information and business participant information to the system server 12. Promotional certificates are then distributed to users through the software application downloaded on the user device as shown in a step 400. In a subsequent step 500, the system 10 can provide advertisements for business participants through the user's Internet-based social media or social networks. The method 50 further includes a step 600 of providing feedback to business participants based on promotional certificate redemption frequency or quantity, and providing a rebate to business participants based on specified parameters, in a step 700.

When the user logs onto the application providing contact to the system 10, a screen of the user device can present digital “buttons”. The buttons can be used by the user to select specific items, enter user data, select the digital certificate from a list of available digital certificates, and the like. A date and a time that the digital certificate is redeemed is identified and recorded in the system 10, such that the digital certificate can only be redeemed once in a pre-determined period of time, such as once per month.

The application will show a group having multiple promotional certificates, for example, approximately 250 promotional certificates, that are available during a predetermined time period and that meet the selection criteria identified by the user. Those promotional certificates not redeemed within the predetermined period of time can be automatically voided by the system 10, and/or repeated or reintroduced in the group in a following period of time. This helps to ensure that each certificate can only be used once during the predetermined time period. An exemplary predetermined time period is one calendar month.

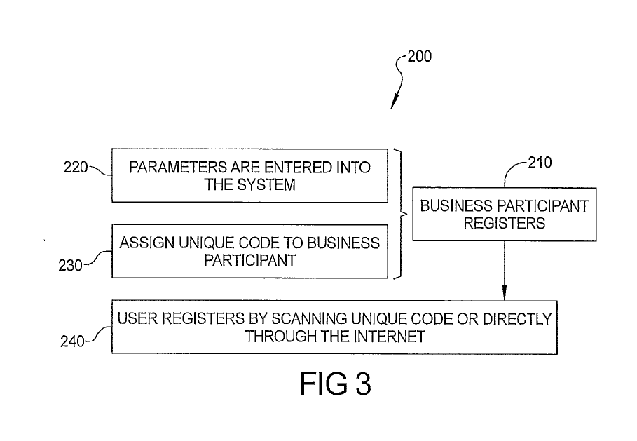

As shown in FIG. 3, a business participant registers with the system in a step 210 by contacting a service provider who will enter business participant parameters into the system as shown in a step 220. These parameters include, but are not limited to promotional certificate appearance, frequency of distribution, value, advertisement designs, and/or description of events or offerings, for example. In particular embodiments, the business participants have access to a portal of the system 10 through the computer network, which allows the business participants to modify the business participant parameters.

Once the business participants register in step 210, a unique code is assigned to the business participant, in a step 230. The unique code can be in any format, such as a unique icon, a unique code number, a bar code, or the like. The unique code may be placed on advertisements at the place of business of the business participants. It is understood that any bar code configured to be scanned by a user device or scanner can be used, as desired, such as a QR code, for example.

In a step 240, a user registers with the system 10 by scanning the unique code with a scanning device of their user device that is configured to scan codes. A registration form is displayed on the user device by scanning the code. The user inputs information in the form such as user name, address, e-mail address, social media information, and other identifying data through the user device. In particular embodiments, in step 240 the user can also choose between a plurality of subscription options during the user registration. The subscription options can include, but are not limited to, types of business participants such as shoe or clothing stores, geographic locations of business participants such as by street, city, county or other area designation, business participants available on selected days of the week, and the like.

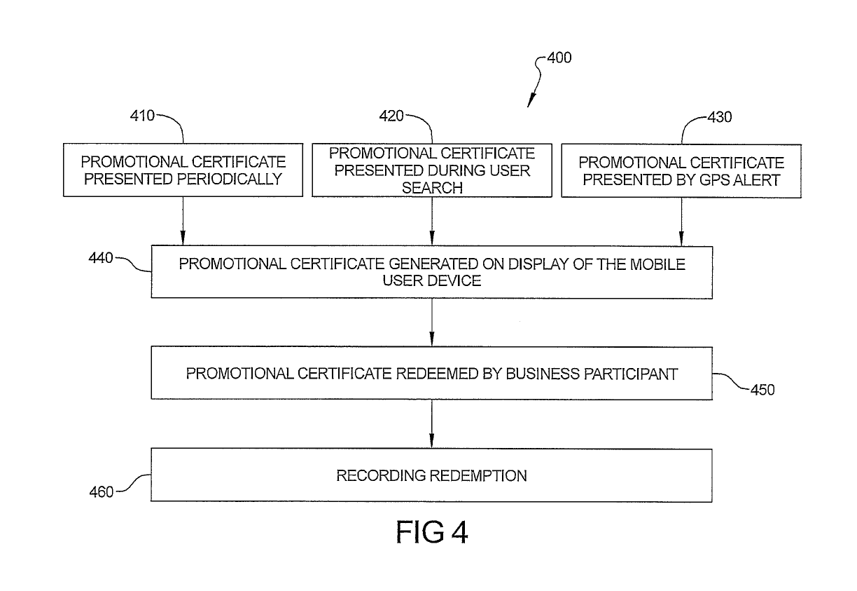

Referring now to FIG. 4, the steps for distributing promotional certificates via the software application on the user device are shown. In a step 400, the user is presented with a promotional certificate through the user device software application. The promotional certificates can be presented to the user periodically as shown in a step 410. For example, the user receives a promotional certificate from the business participant daily, weekly, or monthly, as nonlimiting examples.

Additionally, as shown in a step 420, the promotional certificates can be presented to the user through a user search on the user device. For example, the user can search for business participants by name, type, or geographical location through a map, a list, or other method embedded in the software application on the user device.

The promotional certificates can also be presented to the user through an alert that utilizes the GPS capabilities of the user device as shown in a step 430. For example, a user device having GPS capabilities will notify the user when a business participant is in a specified vicinity of the user device for which a promotional certificate is available. In one embodiment, the vicinity is two miles. However, in other embodiments the vicinity could be more or less than two miles, as desired.

When the GPS system of the user device notifies the user that a business participant is available, the promotional certificate can be identified by the user to the business participant using, for example, a scan code available on the user device that is read by or transmitted to the business participant. In this embodiment, both the user and the business participant must be registered with the service provider in order for both to receive a communication related to the promotional certificate.

Referring again to FIG. 4, the promotional certificate is generated on a display screen of the user device as shown in a step 440. In a most particular embodiment, the promotional certificate generated has a button which is selected by an employee of the business for purposes of redeeming the promotional certificate.

In an alternative embodiment, the promotional certificate includes a unique identifier that may be scanned or recorded by a business participant upon presentation of the promotional certificate. It is understood that the unique identifier may be a bar code, an alphanumeric code or any code configured to be easily recorded, for example. The promotional certificate is redeemed by the business participant in a step 450 by scanning the bar code with a scanner configured to record the barcode or recording the alphanumeric code upon presentation of the promotional certificate by the user.

In certain embodiments, the promotional certificate is interactive to facilitate secured redemption. For example, the promotional certificate can be provided on the user device with a touchscreen that permits a designated employee of the promotional certificate participating business to touch the screen to enter a confirmation code to identify the promotional certificate as being redeemed. The promotional certificate can also be provided on the user device such that the designated employee of the promotional certificate participating business can manually or by electronic transfer enter the confirmation code to identify the promotional certificate as being redeemed.

In a most particular embodiment, the promotional certificate includes a moving or animated authentication symbol to notify the promotional certificate participating business that the promotional certificate is authentic and ready to be redeemed.

In a step 460, after the promotional certificate is redeemed, the redemption is recorded by the system 10, and in particular reported back to the system server 12, for providing subsequent feedback to the promotional certificate participating business that the promotional certificate can no longer be redeemed. Exemplary limitations on the promotional certificates can include a limitation that the promotional certificate can only be redeemed at a specific one of multiple promotional certificate participating businesses, can only be redeemed within a predetermined time period of a day, can only be redeemed within a predetermined set of dates, or only on a certain day of the week, as nonlimiting examples.

As shown in FIG. 5, a step 510 is provided in which the user registers with the system 10 at the place of business of the business participant by scanning the unique code assigned to the business participant. Once the user registers by scanning the unique code as shown in step 510, the user receives an alert in a step 520 notifying the user of the completed registration and providing the user with the business participant advertisements. The alert can be a text message or an e-mail sent to the user device or any form of notification as desired. Additionally, in a step 530 advertisements promoting the business participant are automatically sent to the social media account of the user after the user registers at the place of business of the business participant.

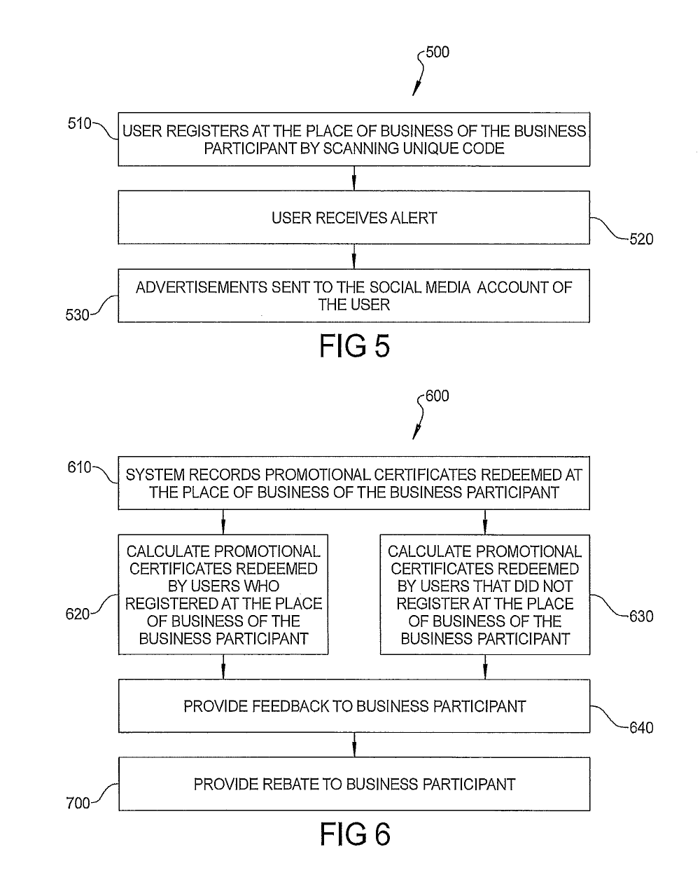

As shown in FIG. 6, providing feedback to business participants based on promotional certificate redemption, as shown in step 600, includes a step 610 of recording the number of promotional certificates redeemed at the place of business of the business participant. The system calculates the number of promotional certificates redeemed by users who registered at the place of business of the promotional certificate participating business in a step 620, and the number of promotional certificates redeemed by users at the place of business of the promotional certificate participating business that did not register at the place of business of the promotional certificate participating business in a step 630. In a step 650, feedback is then provided to the promotional certificate participating business based on the calculations. In another embodiment of the disclosure, the feedback is a detailed report that is sent by an e-mail to the promotional certificate participating business. However, it is understood that the feedback can be provided in any manner as desired. In a non-limiting example, feedback can be provided to the promotional certificate participating business based on total value of promotional certificates redeemed by all users.

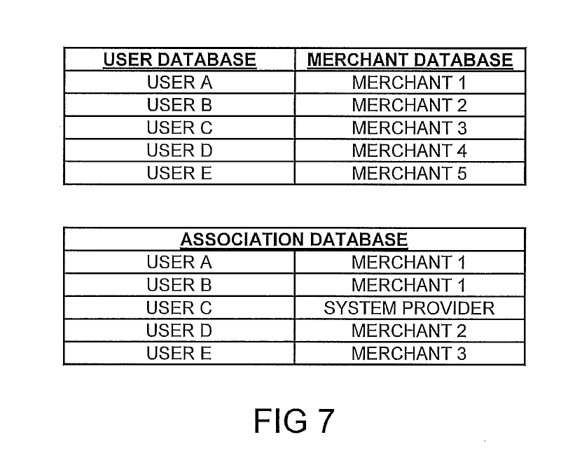

Advantageously, a rebate is provided to the promotional certificate participating business in a step 700 representing promotional certificates redeemed over a predetermined period of time. The rebate can be calculated by the system 10, for example, as a percentage of a value of all promotional certificates redeemed within a predetermined period of time such as within a calendar week or a calendar month at the place of business of the promotional certificate participating business, by users who also registered at the promotional certificate participating business. The association of the users with particular promotional certificate participating businesses, based on where they registered, may be performed by the processor 14 of the server system 12, for example, and stored in a database 18, for example, as shown in FIG. 7. One of ordinary skill in the art appreciates that this particular association and rebate system advantageously encourages participating businesses to register more users at their businesses, in order to benefit from greater rebates. However, it is understood that a rebate can be calculated using any other suitable parameters, as desired.

From the foregoing description, one ordinarily skilled in the art can easily ascertain the essential characteristics of this disclosure and, without departing from the spirit and scope thereof, can make various changes and modifications to the disclosure to adapt it to various usages and conditions.

What is claimed is:

1. A system for distributing promotional certificates, comprising:
a system server having a processor and a memory, the memory in communication with the processor and including at least one database embodied thereon, the database defining a plurality of users, a plurality of participating businesses, and a plurality of promotional certificates associated with the participating businesses, the processor configured to associate in the memory each of the users with either an individual one of the participating businesses or a provider of the system server; and
a user device associated with one of the users and in communication with the system server, the user device having a software application configured to present the promotional certificates for redemption at the participating businesses.

2. The system of claim 1, wherein the user device is configured to receive a code of an advertisement of the individual one of the participating businesses and to transmit the code to the system server, the code causing the processor to associate the user with the individual one of the participating businesses.

3. The system of claim 1, wherein a time and a date when one of the promotional certificates is redeemed is recorded and transmitted to the system server by the user device.

4. The system of claim 1, wherein the user device is a mobile device having a location interface configured to detect when the user device is proximate one of the participating businesses at which one of the promotional certificates is redeemable, and to notify the user that the one of the promotional certificates is available for redemption.

5. The system of claim 1, wherein the user device permits a designated employee of one of the participating businesses to redeem one of the promotional certificates, the user device communicating to the system server that the one of the promotional certificates has been redeemed by the designated employee.

6. The system of claim 5, wherein the designated employee is permitted to redeem the one of the promotional certificates by one of selecting a button of the user device and entering a confirmation code at the user device unique to the one of the participating businesses where the one of the promotional certificates is being redeemed.

7. The system of claim 5, wherein the user device presenting the one of the promotional certificates further shows an animated authentication symbol signifying that the one of the promotional certificates is authentic and ready to be redeemed.

8. The system of claim 1, wherein the system server is configured to communicate to a social media website approved by one of the users a posting on a total value of all of the promotional certificates redeemed by the one of the users during a predetermined period of time.

9. The system of claim 8, wherein the posting further includes an advertisement identifying new ones of the promotional certificates available for redemption.

10. The system of claim 1, wherein the user device presents a list of the promotional certificates for the participating businesses, and permits an opt-out of any one of the participating businesses at which the promotional certificates are redeemable.

11. The system of claim 1, wherein the processor is further configured to calculate a rebate to the individual one of the participating businesses based on the promotional certificates presented for redemption by users associated with the individual one of the participating businesses in the memory of the system server.

12. The system of claim 11, wherein the rebate is calculated as a percentage of a total value of all of the promotional certificates redeemed at the individual one of the participating businesses by all of the users associated with the individual one of the participating businesses in the memory of the system server.

13. The system of claim 12, wherein the promotional certificates redeemed by users not associated with the individual one of the participating businesses in the memory of the system server are not used to calculate the rebate.

14. A system for distributing promotional certificates, comprising:
a system server having a processor and a memory, the memory in communication with the processor and including at least one database embodied thereon, the database defining a plurality of users, a plurality of participating businesses, and a plurality of promotional certificates associated with the participating businesses, the processor configured to associate in the memory each of the users with either an individual one of the participating businesses or a provider of the system server; and
a user device associated with one of the users and in communication with the system server, the user device having a software application configured to present the promotional certificates for redemption at the participating businesses, the user device configured to scan a code of an advertisement of the individual one of the participating businesses, the scanning of the code causing the processor to associate the user with the individual one of the participating businesses, the user device further configured to scan a code of an advertisement of the individual one of the participating businesses, the scanning of the code causing the processor to associate the user with the individual one of the participating businesses,
wherein the processor of the system server is further configured to calculate a rebate to the individual one of the participating businesses based on the promotional certificates presented for redemption by users associated with the individual one of the participating businesses in the memory of the system server, wherein the rebate is calculated as a percentage of a value of all of the promotional certificates redeemed at the individual one of the participating businesses.

15. A method of distributing promotional certificates, the method comprising the steps of:
permitting a user device to be in communication with a system server having a processor and a memory, the memory in communication with the processor and including at least one database embodied thereon, the database defining a plurality of users, a plurality of participating businesses, and a plurality of promotional certificates associated with the participating businesses, the processor configured to associate in the memory each of the users with either an individual one of the participating businesses or a provider of the system server, the user device associated with one of the users and having a software application configured to present the promotional certificates for redemption at the participating businesses;
presenting the promotional certificates on the user device;
allowing the user to select one of the promotional certificates for one of the participating businesses; and
permitting the one of the participating businesses associated with the selected one of the promotional certificates to redeem the selected one of the promotional certificates on the user device, the user device communicating to the system server that the selected one of the promotional certificates has been redeemed.

16. The method of claim 15, further comprising the step of registering one of the users with the system server by receiving a code provided on an advertisement of the individual one of the participating businesses.

17. The method of claim 16, further comprising the step of associating the user with the individual one of the participating businesses associated with the code in the memory of the system server.

18. The method of claim 15, further comprising the step of calculating a rebate by the system server and forwarding the rebate to the individual one of the participating businesses.

19. The method of claim 18, further comprising the step of calculating the rebate as a percentage of a total value of the promotional certificates redeemed at the individual one of the participating businesses during a predetermined period of time by the users associated with the individual one of the participating businesses in the memory of the system server.

20. The method of claim 15, further comprising the step of detecting by the user device when the user is proximate to one of the participating businesses at which one of the promotional certificates is redeemable.
